(19) United States
(12) Patent Application Publication
(10) Pub. No.: US 2003/0218037 A1
(43) Pub. Date: Nov. 27, 2003

(54) Vehicle article carrier

(76) Inventors: Gerard J. Kmita, Allen Park, MI (US); Jeffrey M. Aftanas, Ortonville, MI (US); Milton J. Antonick, Royal Oak, MI (US); Brett J. Borella, Bloomfield Hills, MI (US)

Correspondence Address: HARNESS, DICKEY & PIERCE, P.L.C., P.O. BOX 828, BLOOMFIELD HILLS, MI, 48303, US

(21) Appl. No.: 10/373,584

(22) Filed: Feb. 24, 2003

Related U.S. Application Data
(63) Continuation-in-part of application No. 10/137,696, filed on May 2, 2002.
Application No. 10/137,696 is a continuation-in-part of application No. 09/698,761, filed on Oct. 27, 2000, now Pat. No. 6,516,984.
Application No. 09/698,761 is a continuation-in-part of application No. 09/528,765, filed on Mar. 17, 2000, now Pat. No. 6,338,427.

(51) Int. Cl. B60R 9/04; B60R 9/042; B60P 9/00; B60R 11/00

(52) U.S. Cl. 224/310; 224/309; 224/492; 414/462

(57) ABSTRACT

An article carrier adapted to hold cargo and other articles adjacent a liftgate of a vehicle such as a sport utility vehicle, a station wagon, or minivan. The article carrier includes a pair of supports which are fixedly secured to the roof of the vehicle. A cargo supporting structure having a pair of upper coupling links is pivotally and releasably coupled to the supports. The cargo supporting structure includes a pair of main support members which each include a pair of pivot assemblies. The cargo supporting structure is detachably and pivotally secured to a pair of anchor assemblies attached to the liftgate of the vehicle or the bumper of the vehicle. The three pivot points along each side of the cargo supporting structure enable it to be pivoted with the liftgate when the liftgate is lifted and closed such that the article carrier does not interfere with operation of the liftgate. The entire article carrier can be quickly and easily detached from the vehicle for storage when it is not needed.

### CROSS-REFERENCE TO RELATED APPLICATIONS

This is a continuation-in-part of U.S. patent application Ser. No. 10/137,696 filed on May 2, 2002, presently pending, which is a continuation-in-part of U.S. patent application Ser. No. 09/698,761, filed Oct. 27, 2000, which issued as U.S. Pat. No. 6,516,984 on Feb. 11, 2003, which is a continuation-in-part of Ser. No. 09/528,765, filed Mar. 17, 2000, which issued on Jan. 15, 2002 as U.S. Pat. No. 6,338,427, which in turn claims priority from provisional application No. 60/352,147, filed Oct. 29, 2001.

### FIELD OF THE INVENTION

The present invention relates to vehicle article carrier systems, and more particularly to a vehicle article carrier system secured over a liftgate of a vehicle in a first position, and movable to a second position over a roof of the vehicle.

### BACKGROUND OF THE INVENTION

Vehicle article carriers are used in a wide variety of vehicles to support cargo and various other articles above an outer body surface, such as a roof portion, of a vehicle. Typically, such systems include a pair of side rails or slats which are fixedly secured to the roof portion of the vehicle. Usually a pair of cross bars are secured to the side rails or slats to extend transversely therebetween. The cargo is then positioned on the cross bars and secured down via suitable securing straps or bungee cords so that the cargo is held securely on the article carrier while the vehicle is in use.

One drawback with any conventional vehicle article carrier system is the occasional difficulty of lifting cargo and other articles to be transported up onto the roof portion of the vehicle. This is particularly so if the vehicle is a sport utility vehicle or a mini van, in which case the roof thereof is often at a height which is higher than many individuals can reach easily when attempting to lift cargo onto the article carrier. Removing cargo from the vehicle article carrier can often be just as difficult depending, of course, on the specific cargo, its dimensions and its weight.

Some attempts have been made to overcome this problem by providing a vehicle article carrier which has some form of movable load supporting structure which can be disposed in a temporary position in which cargo can be more easily loaded thereunto. Such systems, for example, are illustrated in U.S. Pat. Nos. 5,649,655; 5,505,579 and 5,417,358.

The systems illustrated in the above-mentioned patents typically suffer from one or more drawbacks. Often, such systems are complex to manufacture, and therefore costly. With some such devices, they cannot be left in a “lowered” position, but rather must be maintained in a retracted position on top of the vehicle roof. Some also do not allow for convenient opening of the liftgate of a vehicle when the cargo supporting portion is in its lowered position.

Yet another drawback with such pre-existing article carrier systems as described above is the inability to remove the cargo supporting portion of the system when it is not needed. It would also be advantageous to be able to collapse the removed cargo supporting portion into a compact arrangement that could be stored in a duffle bag or other like implement and then stored in a garage, or even in the vehicle from which it was removed.

It is therefore a principal object of the present invention to provide a vehicle article carrier having a cargo supporting structure which can be secured over the liftgate of a vehicle to thus allow cargo to be secured thereto without a user having to stand on a ladder or other implement, as with conventional roof mounted article carrier systems.

It is another object of the present invention to provide a vehicle article carrier in which a cargo supporting structure is used to support cargo adjacent a liftgate of a vehicle, and which also permits the liftgate to be lifted and lowered without interference from the article carrier, and further which does not add an appreciable amount of weight to the liftgate.

It is yet another object of the present invention to provide a vehicle article carrier having a cargo supporting structure which is mounted over a liftgate of a vehicle, and where the cargo supporting structure can be quickly and easily detached from the vehicle when the cargo supporting structure is not needed, and which can further be collapsed into a compact arrangement for storage.

### SUMMARY OF THE INVENTION

A vehicle article carrier includes a pair of upper coupling links pivotally connectable with a roof support structure, a pair of main support members pivotally connected to the first pair of links. Each of the main support members has a track portion formed longitudinally along at least a portion thereof. A pair of lower support members are pivotally interconnected with the second pair of links. An actuator pivotally supports and is operable to rotate lower support members about a first rotational axis. Rotation of the lower support members induces rotation of the second pair of links about a second axis of rotation to move the upper coupling links and the main support members between a lowered position and a stowed position. The actuator is preferably one of either a hydraulic actuator, or an electrical actuator.

The hydraulic actuator includes a gearbox, an actuation arm, and a hydraulic piston. The gearbox has upper and lower sprocket gears interconnected by a chain, or belt. The lower sprocket is preferably of a larger diameter than the upper sprocket. The actuation arm is fixed for rotation with and extends from the lower sprocket. An end of the actuation arm is pivotally connected to a piston rod of the hydraulic piston. A piston housing of the hydraulic piston is anchored to a vehicle structure. A controller communicates with the hydraulic piston to selectively enable a flow of pressurized fluid thereto. It is anticipated that the hydraulic piston may be either hydraulic, or pneumatic.

Alternatively, the electric actuator includes a gearbox having upper and lower sprocket gears interconnected by a chain, or belt. The electrical actuator further includes an electric motor that is operable to drive the lower sprocket. The controller communicates with the electric motor to selectively drive the lower sprocket in either a clock-wise (CW), or counterclock-wise (CCW) direction.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The various advantages of the present invention will become apparent to one skilled in the art by reading the following specification and subjoined claims and by referencing the following drawings in which:

FIG. 1 is a rear perspective view of a vehicle including a multi-position, articulating, article carrier apparatus in a lowered position, in accordance with the present invention;

FIG. 2 is a rear perspective view of the apparatus and vehicle shown in FIG. 1 with the apparatus articulated to an intermediate position;

FIG. 3 is a plan view of the apparatus of FIG. 1 showing the apparatus in a stowed position in which a cargo supporting structure thereof is disposed adjacent a roof of the vehicle;

FIG. 4 is a perspective view of a latching assembly secured to a support beam on a rear bumper of the vehicle;

FIG. 5 is a side cross sectional view of a free end of the cargo supporting structure secured to the latching assembly, by a lower locking assembly taken along section line 5-5 of FIG. 1;

FIG. 6 is the side cross sectional side view of the latching assembly of FIG. 5 with the lower locking assembly of the cargo supporting structure unlatched therefrom;

FIG. 6a is a fragmentary side, cross-sectional view of FIG. 5, illustrating the latching lever of FIG. 5 engaging the latching assembly as the latching lever is urged into the latching assembly;

FIG. 7 is a perspective fragmentary view of a portion of a torque rod assembly of the cargo supporting structure illustrating one of the lower locking assemblies at one end of the torque rod assembly;

FIG. 8 is a cross sectional view of a portion of the torque rod assembly shown in FIG. 7 taken along section line 8-8 of FIG. 7;

FIG. 9 is a cross sectional view of the torque rod assembly taken along section line 9-9 of FIG. 8;

FIG. 10 is a plan view of a rear portion of a side rail showing an articulating assembly and a small portion of the cargo supporting structure;

FIG. 11 is a perspective view of the articulating assembly and the rearmost end of the side rail;

FIG. 11a is a plan view of an end portion of the articulating assembly illustrating a pair of rollers that enable rolling movement of the articulating assembly along its associated side rail;

FIG. 12 is a side view of the articulating assembly when the cargo supporting structure is the lowered position shown in FIG. 1;

FIG. 13 is a side view of the articulating assembly when the cargo supporting structure is in the intermediate position shown in FIG. 2;

FIG. 14 is a side cross sectional view of the articulating assembly taken along section line 14-14 of FIG. 10, with the cargo supporting structure is in the lowered position;

FIG. 15 is a side cross sectional side view of the articulating assembly of FIG. 14 with the cargo supporting structure in the intermediate position;

FIG. 16 is a partial cross sectional view of the side rail taken along section line 16-16 of FIG. 11;

FIG. 17 is a side cross sectional view of the upper locking assembly of one of the rear supports, taken along section line 17-17 of FIG. 3;

FIG. 18 is a perspective view of a first alternative embodiment of the article carrier apparatus;

FIG. 19 is a perspective view of the article carrier apparatus of FIG. 18 with the cargo supporting structure in the lowered position;

FIG. 20 is a perspective view of a second alternative embodiment of the article carrier apparatus;

FIG. 21 is a perspective view of the article carrier of FIG. 20 with the cargo supporting structure in the lowered position;

FIG. 22 is a perspective view of a third alternative preferred embodiment of the article carrier apparatus;

FIG. 23 is a side view of the article carrier apparatus of FIG. 22, with a liftgate of the vehicle in the open position;

FIG. 23A is a cross sectional end view taken along section line 23A-23A of FIG. 22;

FIG. 24 is a perspective view of a main support member showing a cross bar secured thereto in a storage arrangement when the article carrier apparatus is removed from the vehicle;

FIG. 25 is an exploded perspective view of components comprising an upper pivot assembly;

FIG. 26 is a perspective view of an alternative preferred embodiment of the upper pivot assembly;

FIG. 27 is an end view of a support an upper coupling link pivotally coupled thereto;

FIG. 28 is an exploded perspective view of an anchor assembly fixedly attached to the rear liftgate;

FIG. 29 is a side cross sectional view of a portion of the lower pivot assembly engaged with the anchor assembly;

FIG. 30 is a side view of a hydraulically actuated article carrier apparatus; and

FIG. 31 is a side view of an electrically actuated article carrier apparatus.

### DETAILED DESCRIPTION OF THE PREFERRED EMBODIMENTS

The following description of the preferred embodiments is merely exemplary in nature and is in no way intended to limit the invention, its application, or uses.

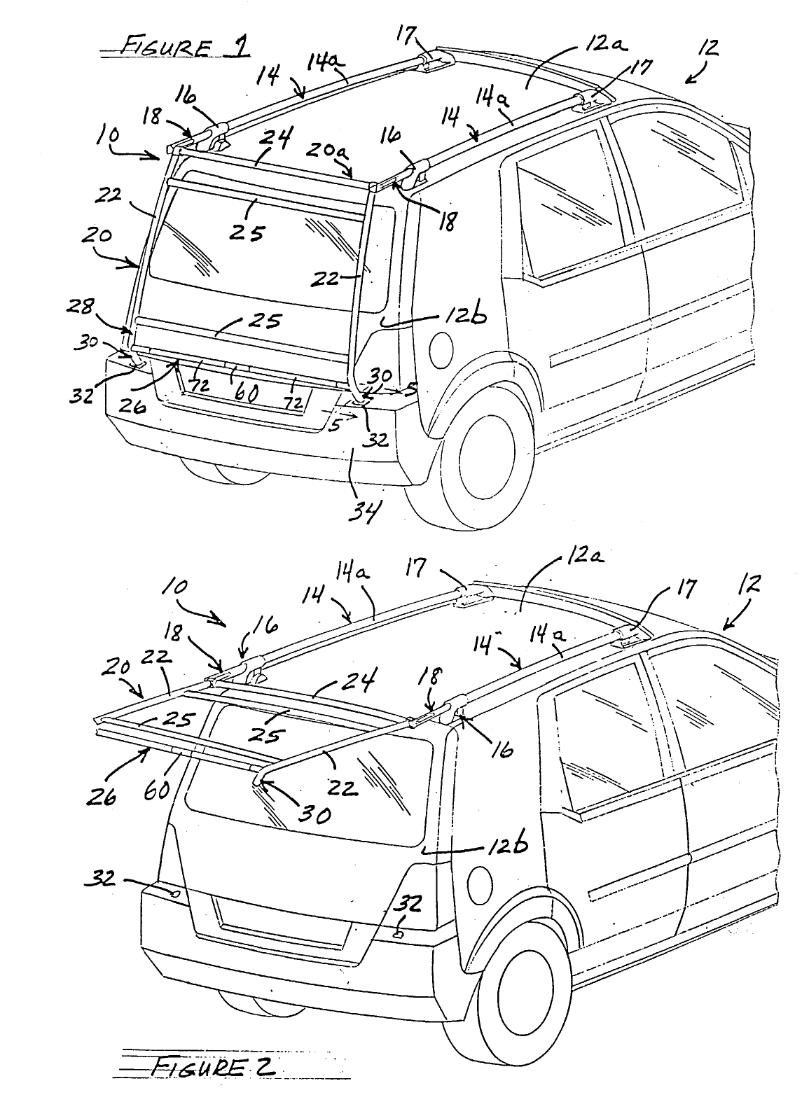

Referring to FIG. 1 a multi-position, articulating, vehicle article carrier apparatus 10 is shown. The apparatus 10 is shown secured to a roof portion 12a of a motor vehicle 12. While the motor vehicle 12 is illustrated as a sport utility vehicle (SUV), it will be appreciated that the apparatus 10 could also be used with minivans, station wagons, and a wide variety of other vehicles, and is therefore not limited to use with any particular type of vehicle.

The apparatus 10 includes a pair of side rails 14 adapted to be fixedly secured to the roof portion 12a of the vehicle 12. Each side rail 14 includes a rear support 16 and a front support 17 which support a main rail 14a of the side rail 14 above the roof portion 12a. Each of the main rails 14a of the side rails 14 preferably comprise C-shaped channels.

A pair of articulating mechanisms 18 are engaged with the side rails 14 so as to be movable along each of the side rails 14. The articulating mechanisms 18 are pivotably secured to a cargo supporting structure 20. The cargo supporting structure 20 includes a frame comprised of side members 22, a transversely extending top frame member 24 and an actuator bar assembly 26. At least one cross bar 25, and more preferably a pair of cross bars 25, are disposed on the cargo supporting structure 20 extending between the side members 22. The cross bars 25 may be fixedly secured to the side members 22 by clamping assemblies, or some other means to permit adjustable positioning of the cross bars 25 along the side members 22. Securing straps such as bungee cords may be used to secure cargo on the cross bars 25. A lower, or free end 28 of the cargo supporting structure 20 includes a pair of lower locking assemblies 30. The lower locking assemblies 30 are adapted to latch with a corresponding pair of latching assemblies 32 disposed within a rear bumper 34 of the vehicle 12.

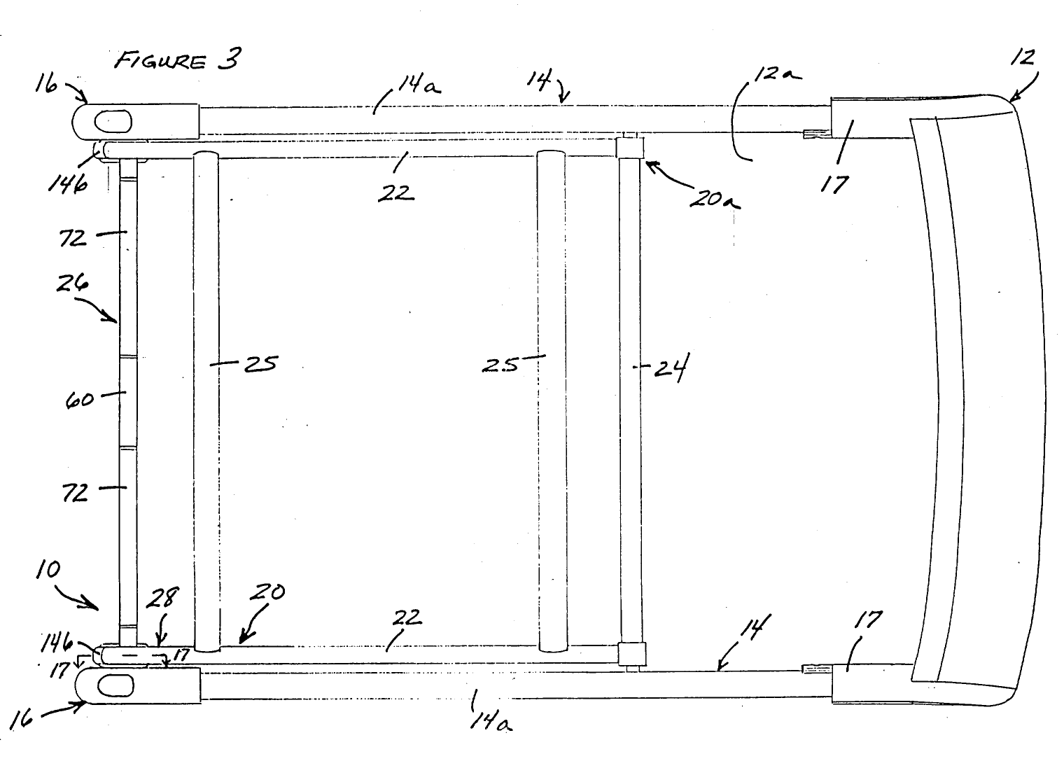

Referring to FIGS. 1 through 3, the apparatus 10 can be secured in a lowered position disposed over a liftgate 12b, as shown in FIG. 1. In this position cargo is carried on the cargo supporting structure 20 through the use of suitable fastening straps, bungee cords, or like components, which secure the cargo to the cross bars 25. In FIG. 2, the cargo supporting structure 20 is shown raised to an intermediate position. This is accomplished by actuation of the actuator bar assembly 26 to release the lower locking assemblies 30 from the latching assemblies 32, then lifting upwardly on the free end 28 of the cargo supporting structure 20. FIG. 3 shows the cargo supporting structure 20 in a stowed position slid forwardly over the roof 12a of the vehicle 12. The stowed position the lower locking assemblies 30 are locked to a corresponding pair of upper locking assemblies 36 associated with the two rear supports 16.

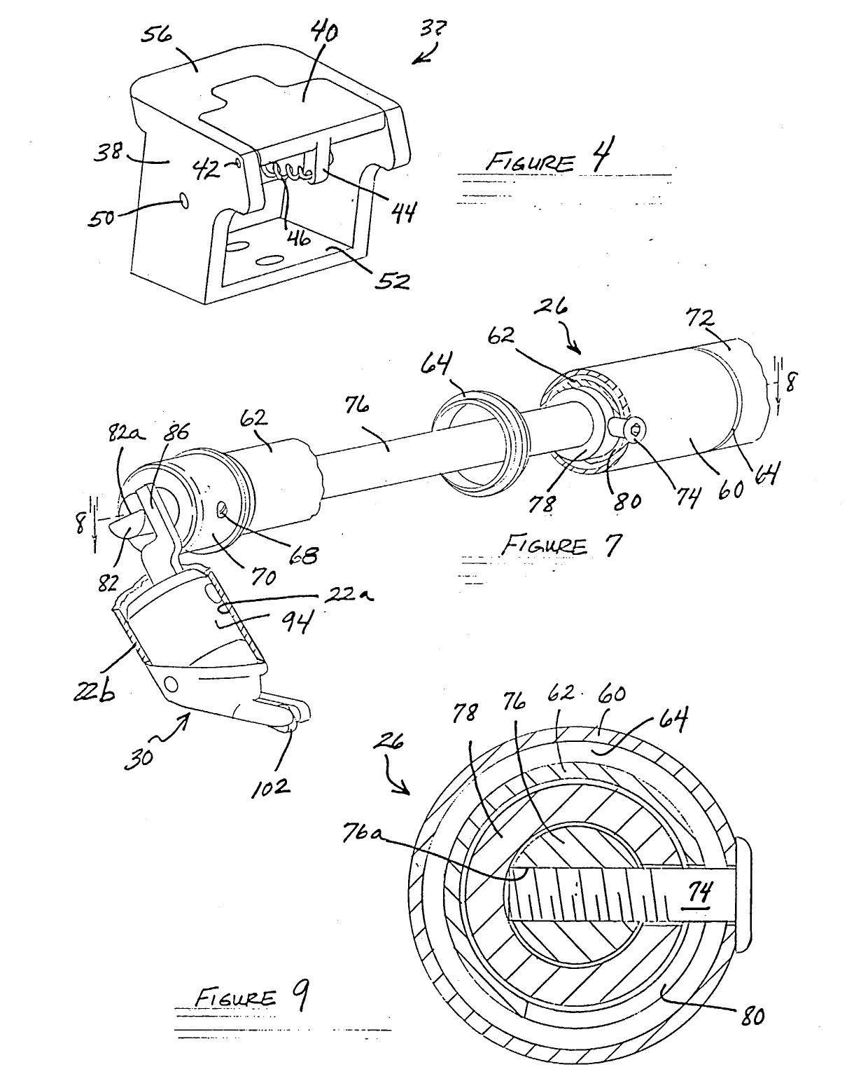

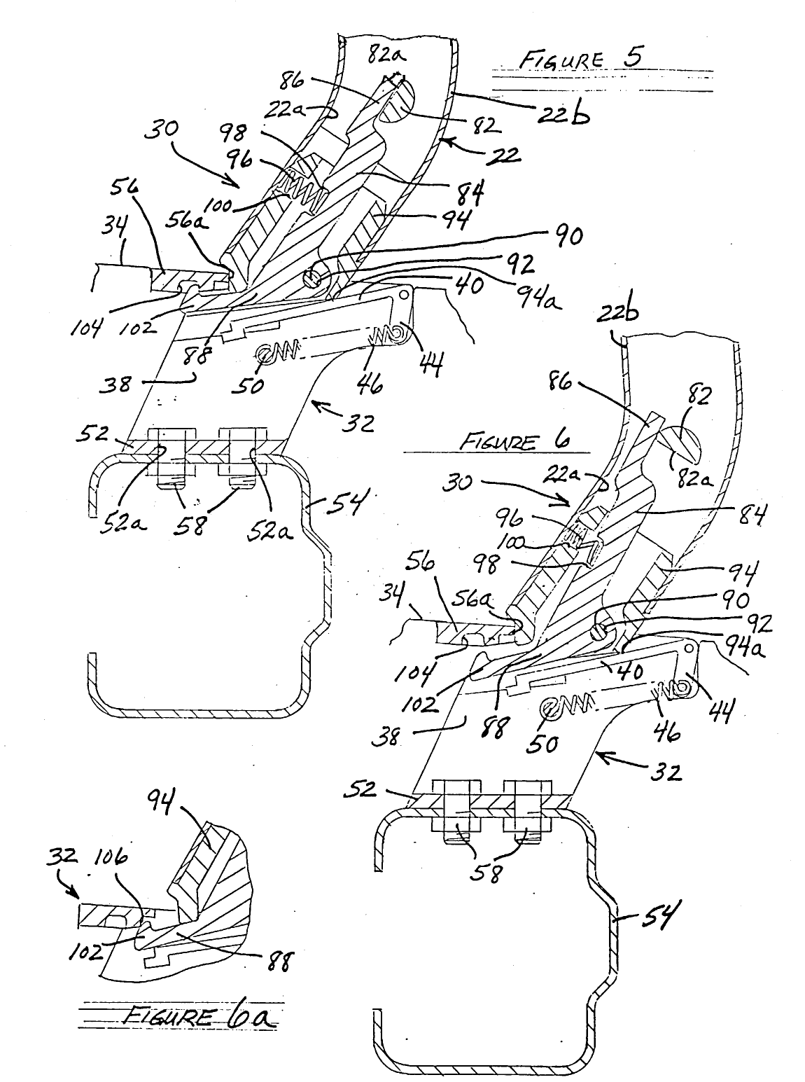

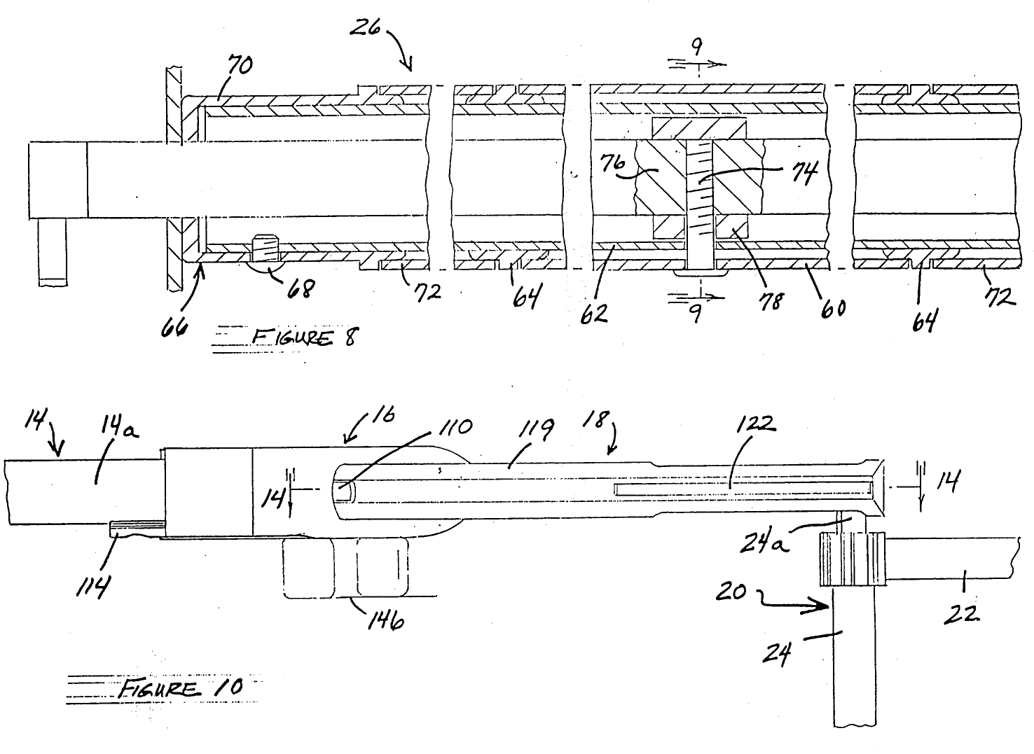

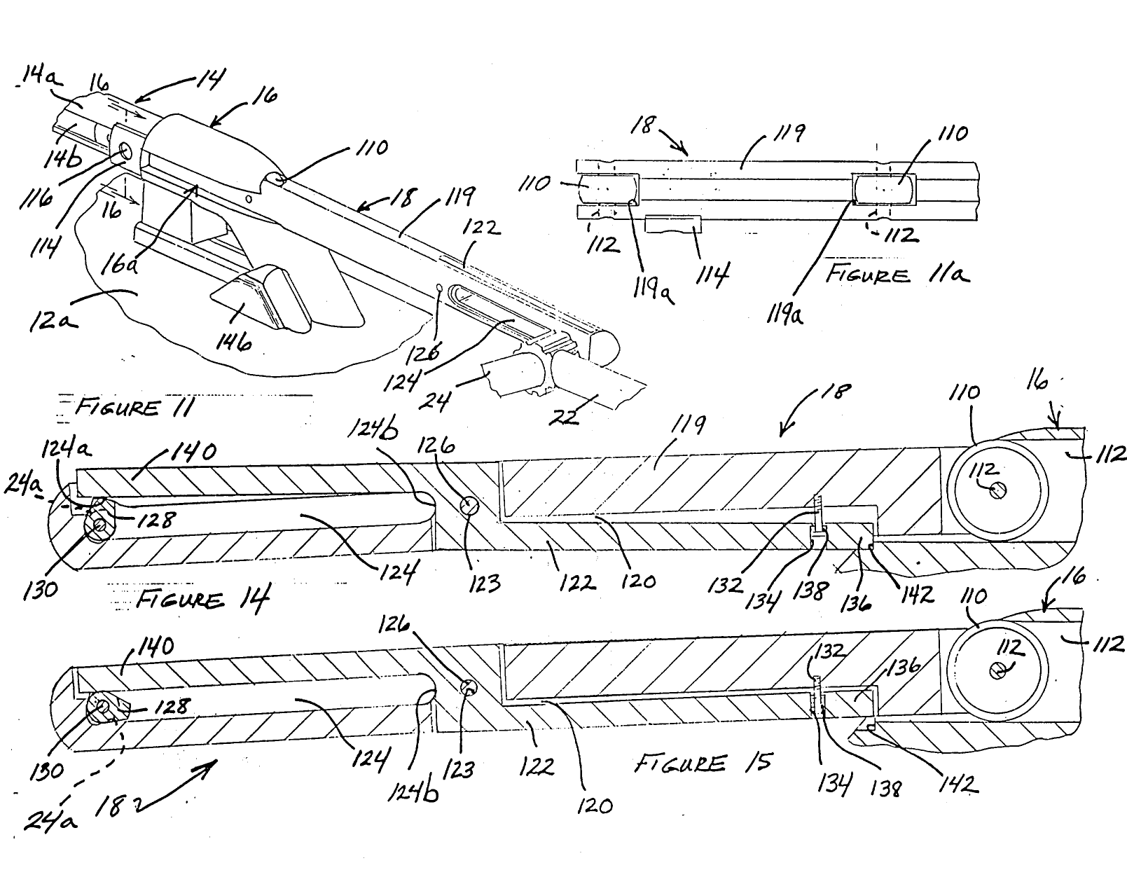

Referring now to FIGS. 4 and 5, one of the latching assemblies 32 is shown. The latching assembly 32 includes a main body portion 38 and a latching door 40 pivotably secured by a pivot pin 42 to the main body portion 38. The latching door 40 includes a lower end 44 which is biased by a spring 46 secured to a transversely extending pin 50. Thus, the latching door 40 is constantly biased into the closed position shown in FIG. 4. A base 52 enables the main body 38 to be secured to a structural frame member 54 disposed within the bumper 34. The base portion 52 is preferably secured to the structural member 54 by a plurality of threaded fastening members 58 extending through apertures 52a. An upper wall 56 of the main body 38 sits generally flush with an upper outer surface of the bumper 34, presenting an aesthetically pleasing appearance whether or not the cargo supporting structure 20 is in the lowered position shown in FIG. 1. Referring now to FIGS. 7-9, the actuator bar assembly 26 will be described. Referring specifically to FIGS. 7, and 8, the actuator bar assembly 26 includes a centrally disposed, manually graspable, and rotatable member 60. The rotatable member 60 is disposed over a first sleeve 62, and supported by a pair of support rings 64, which are also disposed over the first sleeve 62. The first sleeve 62 extends completely to opposite ends 66 of the actuator bar assembly 26, and is secured by at least one fastening member 68 within an end cap 70. A free wheeling sleeve 72 is disposed on each side of the rotatable sleeve 60 in between one of the supports 64 and one of the end cap portions 70. The free wheeling sleeve 72 rotates freely while being grasped when the free end 28 of the cargo supporting structure 20 is lifted from the lowered position of FIG. 1 into the intermediate position of FIG. 2.

With further reference to FIGS. 8 and 9, the rotatable sleeve 60 is secured to a torque rod 76 via a threaded member 74 extending into a threaded bore 76a in the torque rod 76. A spacer sleeve 78 (also shown in FIG. 7) also receives the threaded member 74 therethrough. The first sleeve 62 includes a slot 80 extending over an arc of slightly greater than 90°. The slot 80 enables the rotatable sleeve 60 and the threaded member 74 to rotate without interference from the first sleeve 62. Thus, when the rotatable sleeve 60 rotates, the rotational movement is transmitted to the torque rod 76.

With specific reference to FIG. 7, each opposite end of the torque rod 76 includes a half moon shaped protrusion 82 which forms a camming surface 82a. The camming surface 82a is used to control locking and unlocking of the associated lower locking assembly 30, which will be described momentarily. It will thus be appreciated that the actuator bar assembly 26 enables an unlocking action to be effected which simultaneously releases the two lower locking assemblies 30 from their respective latching assemblies 32, through a short twisting motion of the rotatable sleeve 60. Thus, unlocking of the actuator rod assembly 26 from the lower locking assemblies 32 can be effected with only one hand of a user and with a simple, short and convenient rotational movement of the rotatable sleeve 60.

Referring now to FIGS. 5-7, the construction and operation of one of the pair of lower locking assemblies 30 will be described. Each lower locking assembly 30 includes a latching lever 84 having an upper end 86 and a lower end 88. The latching lever 84 is pivotally mounted via a pivot pin 90 which extends through an aperture 92 in the lever 84 and also through a main body portion 94 which partially encloses the latching lever 84.

With specific reference to FIG. 5, a spring 96 is disposed against an inside surface 22a of a tubular portion 22b of the side member 22, and extends through an opening 100 in the main body portion 94 into a notch 98 formed in the latching lever 84. The spring 96 biases the lower end 88 of the latching lever 84 upwardly into a closed or latched position, which is shown in FIG. 5.

With reference to FIGS. 5, 6 and 7, when the rotatable sleeve 60 is grasped with one hand and rotated, the camming surface 82a of the protrusion 82 rotates to urge the upper end 86 of the latching lever 84 pivotally about the pivot pin 90. As the latching lever 84 rotates, the lower end 88 thereof is drawn away from the upper wall 56 of the latching assembly 32 (FIG. 6). This enables a lip 102 of the latching lever 84 to be drawn out of a notch 104 formed in an undersurface of the upper wall 56. While the rotatable sleeve 60 is held in the rotated position, the user lifts the free end 28 of the cargo supporting structure 20 upwardly and away from the latching assembly 32.

When the free end 28 of the cargo supporting structure 20 is lowered into latching engagement with the latching assemblies 32, no rotational movement of the rotatable sleeve 60 is required for proper latching of the lower locking assemblies 30 to occur. As the lower end 88 of each latching lever 88 contacts the respective latching door 40, an edge 94a of the main body 94 engages the latching door 40 and urges this component downwardly into the position shown in FIGS. 5 and 6. Referring to FIG. 6a, further lowering movement of the cargo supporting structure 22 causes the lip 102 to engage an interior edge 106 of the upper wall 56. Further lowering movement causes the lip 102 to ride over the interior edge 106 before snapping into engagement in the notch 104 (FIG. 5).

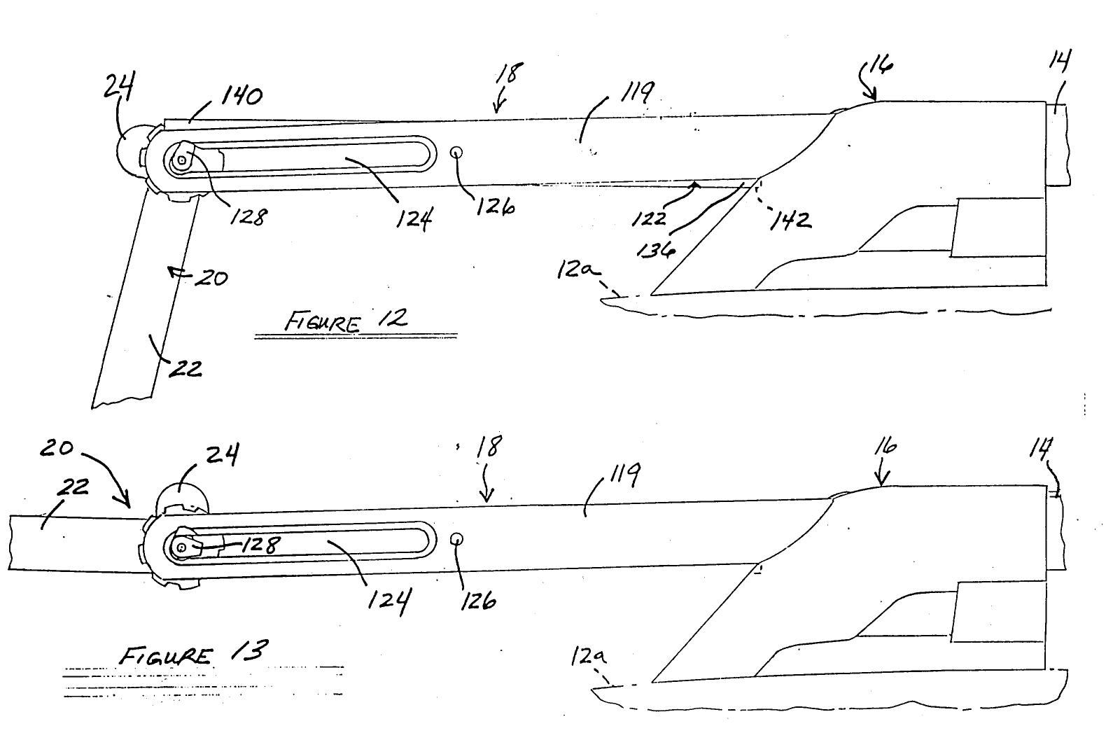

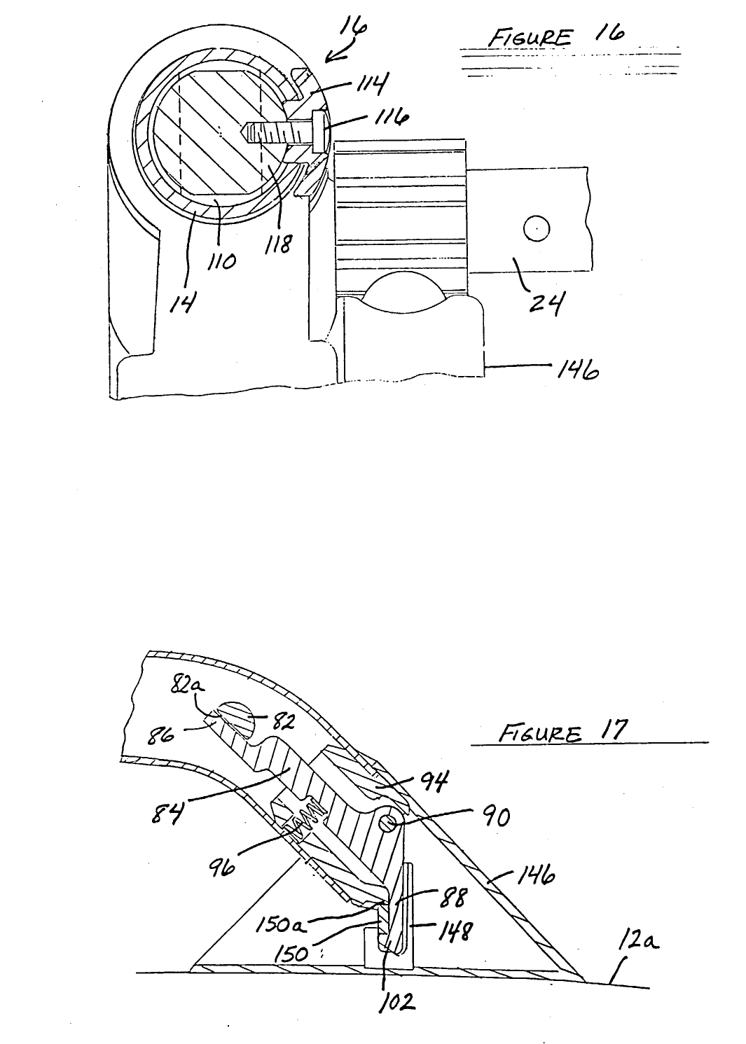

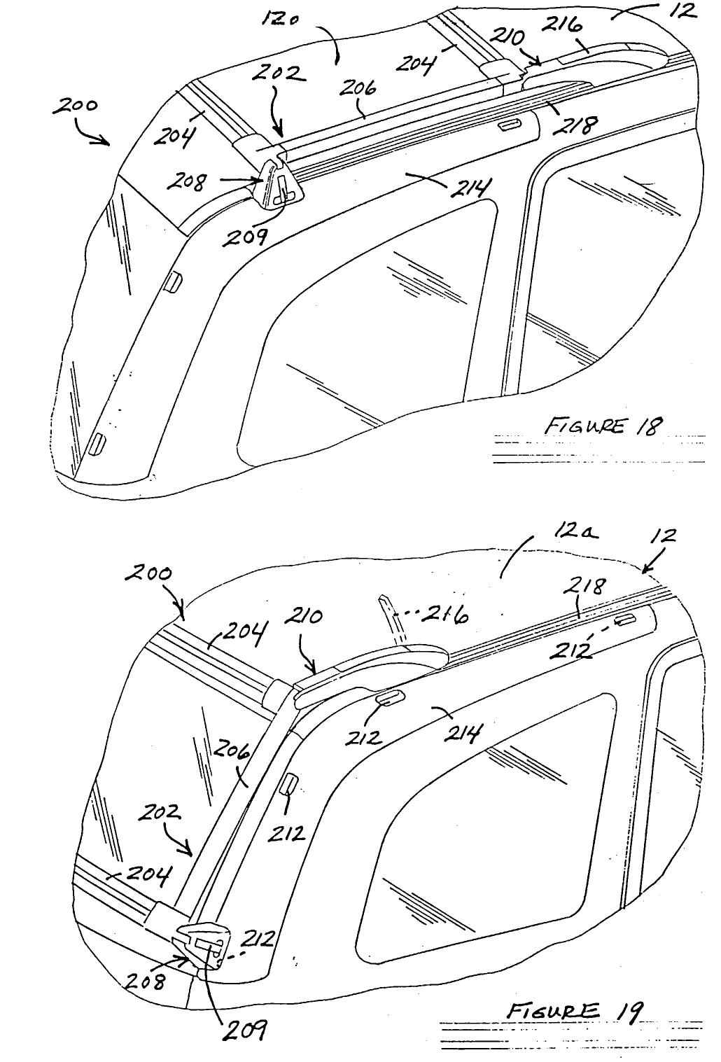

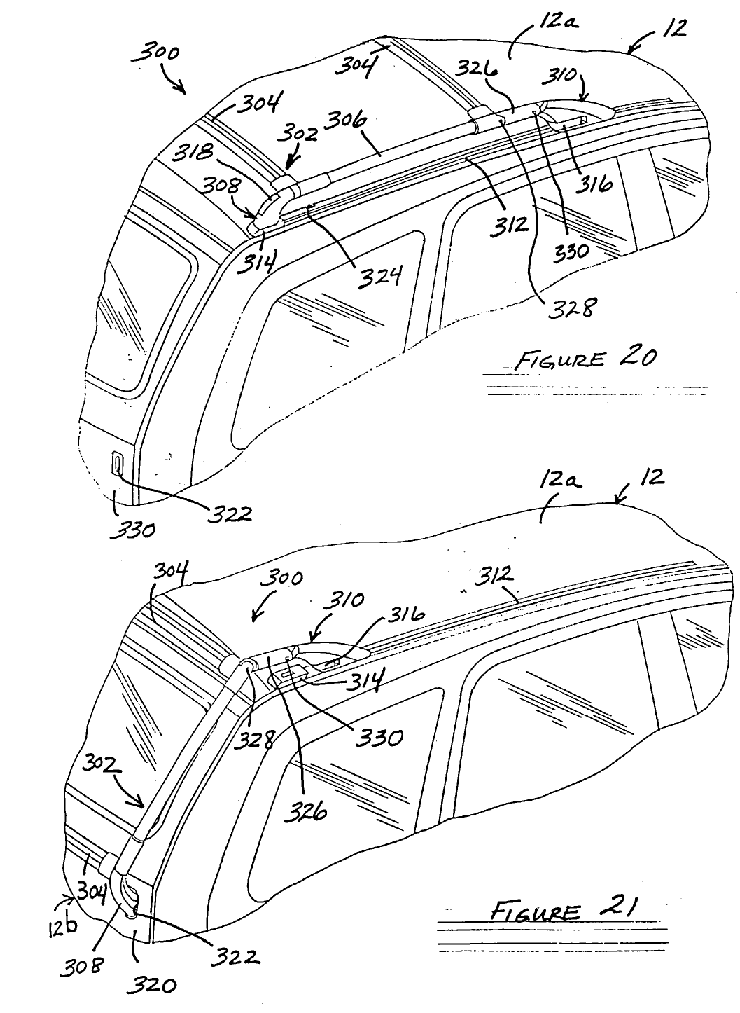

Referring now to FIGS. 10-15, the construction and operation of the articulating mechanisms 18 will be described. With initial reference to FIGS. 10, 11 and 11a, each articulating mechanism 18 includes a pair of rollers 110 which are pivotally secured via axles 112 within cut-outs 119a of a support bar 119. The support bar 119 is sized so as to be able to fit within a C-shaped channel 14b of the side rail 14 and through a C-shaped channel 116a (FIG. 11) in the rear support 16. During assembly, the articulating mechanism 18 is inserted through the C-shaped channel 116a in the rear support 16 and a stop member 114 is secured to the support bar 119 via a threaded member 116. The stop member 114 prevents the articulating mechanism 18 from being withdrawn beyond a predetermined point from its respective side rail 14.

With further reference to FIGS. 11 and 14, the support bar 119 includes a slot 120 formed therein, and within which is disposed a locking bar 122. The locking bar 122 is pivotally mounted at a central aperture 123 by a pivot pin 126 extending through the support bar 18. An elongated, linear slot 124 is also formed in the support bar 18. The slot 124 further includes a relief 124a to enables clearance for a cam lobe 128. The slot 124 may vary in length, but in one preferred form is between about six-nine inches.

With reference to FIGS. 14 and 15, a threaded member 132 extends through an opening 134 in a first end 136 of the locking bar 122. The threaded member 132 captures a biasing member 138 within the opening 134. Biasing member 138 serves to provide a constant biasing force which tends to bias the first end 136 of the locking bar 122 upwardly into the position shown in FIG. 15.

With reference to FIGS. 10 and 14, the top frame member 24 includes an axle 24a at each end thereof. The axles 24a each have attached thereto one of the cam lobes 128 at their outermost ends. Thus, the axles 24a pivotally support the cargo supporting structure 20 from the articulating mechanisms 18. Importantly, the axles 24a are able to slide within the elongated slots 124 when the cargo supporting structure 20 is moved from the intermediate position of FIG. 2 to the position shown in FIG. 3.

Referring now to FIGS. 12, 13, 14 and 15, when the cargo supporting structure 20 is in the lowered position shown in FIG. 1, the side members 22 are disposed in the position shown in FIG. 12. In this position the cam lobe 128 is engaged in the relief portion 124a, as illustrated in FIG. 14. This enables the cam lobe 128 to lift a second end 140 of the lock bar 122 which causes the first end 136 to project outwardly of the support bar 119. The first end 136 abuts a notch 142 formed in the rear support 16, which prevents the articulating mechanism 18 from moving inadvertently towards and into the support member 16 when the cargo supporting structure 20 is in the lowered position of FIG. 1. Thus, when in the lowered position shown in FIG. 1, the cargo supporting structure 20 is fixedly disposed. The upper end 20a cannot be pulled outwardly away from the upper supports 16 because of abutting engagement of the stop members 114 with their respective supports 16. Abutting engagement of the first end 136 of each locking bar 122 with the notch 142 of each support 16 prevents the upper end 20a from being pushed in toward the side rails 14. Accordingly, cargo supported on the cross bars 25 of the cargo supporting structure 20 can be supported just as securely with the structure 20 in the lowered position as when the structure 20 is disposed over the roof 12a of the vehicle 12.

When the cargo supporting structure 20 is lifted into the intermediate position, shown in FIG. 2, the cam lobe 128 rotates in accordance with rotational movement of the top frame member 24 (FIG. 1), into the position shown in FIG. 13. Rotation of the cam lobe 128 enables the spring 138 to bias the first end 136 of the locking bar 122 upwardly into the position shown in FIG. 15. In this position the locking bar 122 is now able to clear the notch 142. Accordingly, the entire articulating mechanism 18 may be urged forwardly (i.e., to the right in the drawings of FIGS. 12-15) through the C-shaped channels 16a in each of the rear supports 16. This unlocking action is further accomplished automatically by raising the free end 28 of the cargo supporting structure 20 into the intermediate position shown in FIG. 2.

Once the cargo supporting structure 20 has been raised into the position shown in FIG. 2, the entire cargo supporting structure 20 can be pushed forwardly until positioned over the roof 12a of the vehicle 12. During the initial six-nine inches of forward travel, the axles 24a slide forwardly within the elongated slots 124 before contacting forward ends 124b of the slots 124. This six-nine inches of travel provides the distance necessary to place the pivot axis defined by the axle portions 24a sufficiently behind the vehicle 12 so that the vehicle 12 does not interfere with lowering pivotal movement of the cargo supporting structure 20.

Another important advantage of the articulating mechanisms 18 is that they effectively enable the top frame member 24 to be positioned rearwardly of the pivot axis of the liftgate 12b of the vehicle 12 such that the cargo supporting structure 20 can be lifted with the liftgate 12b without first having to place the structure 20 over the roof portion 12a of the vehicle 12. Thus, access can easily be gained to the rear of the vehicle 12 once the cargo supporting structure 20 and liftgate 12b are both in the raised position.

Referring now to FIGS. 11 and 17, the securing of one of the lower locking assemblies 30 to one of the upper locking assemblies 36 (also shown in FIG. 3) will be described. Each of the upper locking assemblies 36 comprises a housing 146, which is preferably integrally formed with one of the rear supports 16. Within the housing 146 is upstanding structure 148 and a transversely extending latch member 150. When the cargo supporting structure 20 is to be secured over the roof 12a of the vehicle 12, it is urged into position such that the lower locking assembly 30 is over, but slightly forwardly, of the upstanding structure 148. The locking assembly 30 is then lowered into an interior area of the housing 146. As the lower locking assembly 30 is lowered into the interior area of the housing 146, the lip 102 of the latch lever 84 contacts an upper edge 150a of the transversely extending latch member 150 and pivots slightly against the biasing force of the spring 96 so as to clear the edge 150a. The lip portion 102 then latches under the latch structure 150. In the position shown in FIG. 17, the lower locking assembly 30 is secured against movement.

Unlocking of the lower locking assembly 30 is accomplished by a user grasping and rotating the rotatable sleeve 60, which causes the latching lever 84 to pivot counterclockwise in the drawing of FIG. 17. While holding the rotatable sleeve 60 in its rotated position against the biasing force of spring 96, the user may then push the entire cargo supporting structure 20 forwardly just slightly before lifting the free end 28 of the structure 20 and then pulling same away from the vehicle 12 into the position shown in FIG. 2. Accordingly, unlatching of the cargo support structure 20 from the position shown in FIG. 3 is accomplished by grasping the rotatable sleeve 60 and, from a single position behind the vehicle 12, articulating the actuator bar assembly 26 to clear the upper locking assembly 36. Thus, there is no need to separately unlock each of the lower locking assemblies 30. This significantly adds to the convenience and ease in using the apparatus 10.

From the foregoing description, it will be appreciated that the apparatus 10 of the present invention provides an articulatable article carrier assembly which enables cargo to be carried either in a generally horizontal position over the liftgate of a vehicle, or on top of the vehicle. The apparatus 10 of the present invention significantly eases the manner with which cargo may be loaded, since the cargo need not be positioned directly on top of the vehicle 12 but rather on the cross bars 25 while the cargo supporting structure 20 is disposed over the liftgate 12b. In this regard, it will be appreciated that one or both of the cross bars 25 could include perpendicularly extending portions which serve to temporarily support cargo which is positioned on the cross bars 25 when the cargo supporting structure 20 is in the lowered position shown in FIG. 1. The apparatus 10 can further be locked and unlocked from the position shown in FIGS. 1-3 with a simple, single movement of the rotatable sleeve 26, which thus serves to significantly enhance the ease with which the cargo supporting structure 20 is moved between its various positions.

Referring now to FIGS. 18 and 19, an alternative preferred embodiment 200 of the multi-position, articulating, vehicle article carrier apparatus is illustrated. The apparatus 200 includes a cargo supporting structure 202 comprising a pair of cross bars 204 and a pair of side members 206 (only one being visible). With the apparatus 200, however, a pair of rear supports 208 and a pair of front supports 210 are used to support the cargo supporting structure 202 above the outer body surface 12a of the vehicle 12. Each rear support 208 includes a suitable latching structures which is actuated through opening and closing of a pivoting lever 209 to engage a suitably shaped cavity 212 (FIG. 19) in an outer body surface 214 of the vehicle 12. The front supports 210 each include a latching structure therein which is locked and unlocked via a liftable locking lever 216 (shown in phantom in the lifted position in FIG. 19).

When the apparatus 200 is in the position shown in FIG. 18, the cargo supporting structure 202 is disposed over the roof 12a of the vehicle 12. The internal locking structure within the front supports 210 secures the front supports to conventional slats 218, which are fixedly secured to the roof 12a of the vehicle 12, and which each include channels captively holding portions of the front supports 210 to the slats 218. This construction of the slats and the interengagement of the front supports 210 with the slats 218 to permit sliding movement of the front supports 210 along the slats 218 is well known in the art. Patents of the assignee of the present application, which disclose suitable constructions for the locking assembly of the front support 210, which could be utilized with little or no modifications, are U.S. Pat. Nos. 4,899,917; 4,972,983; 4,982,886; 5,385,285 and 5,579,970, which are all incorporated by reference herein. In FIG. 19, the cargo supporting structure 202 is shown disposed over the liftgate 12b of the vehicle 12. The rear supports 208 are locked at one of a plurality of positions defined by the cavities 212.

Referring now to FIGS. 20 and 21, a multi-position, articulating, vehicle article carrier 300 in accordance with yet another alternative preferred embodiment of the present invention is shown. The apparatus 300 is similar to the apparatus 200 and includes a cargo supporting structure 302 comprised of a pair of cross bars 304 and a pair of side members 306 (only one being visible). The cargo supporting structure 302 is supported above the roof 12a of the vehicle 12 by a pair of rear supports 308 and a pair of front supports 310 (with only one of each support 308 and 310 being visible). The front supports 310 are disposed on conventional slats 312 such that the front supports 310 can be moved slidably along the slats. The slats 312 are fixedly secured to the roof 12a of the vehicle 12. Each slat 312 further includes a latching assembly 314 to which one of the rear supports 308 may be releasably secured.

To move the cargo supporting structure 302 from the position shown in FIG. 20 into the position shown in FIG. 21, the front supports 310 are unlatched by pulling outwardly on levers 316 of each of the front supports 310. This unlocks each front support 310 from the associated slat 312 and enables the front support 310 to slide along its associated slat 312. Each rear support 308 is also unlatched from the associated latching assembly 314 by lifting a latching lever 318. The cross bar 304 extending between the rear supports 308 is lifted off of the latching assemblies 314, and the entire cargo supporting structure 302 pulled rearwardly so as to extend over the liftgate 12b. The rear supports 308 are then latched to suitable latching structures formed in the liftgate 12b at areas 322. The front supports 310 are then latched by closing the levers 316, which locks them on the slats 312 at the position shown in FIG. 21. If desired, notches 324 (one of which is shown in FIG. 20) could be formed in the slats 312 to define a specific position, at which the front supports 312 must be placed in before the same can be locked to the slats 312.

The apparatus 300 also provides a coupling member 326 associated with each front support 310, which provides two pivot points 328 and 330. The two pivot points 328, 330 are needed because the point of rotation about which the liftgate 12b rotates is laterally offset of the point of rotation of the cargo supporting structure 302. This enables the cargo supporting structure 302 to be easily articulated, together with the liftgate 12b, as the liftgate 12b is lifted, and without the need to first unlock the front supports 310 or the rear supports 308. Thus the apparatus 10 can be lifted simultaneously from the position shown in FIG. 21 into an intermediate position, such as in FIG. 2, before being pushed onto a position over the roof 12a, without any binding action occurring at the coupling member 326.

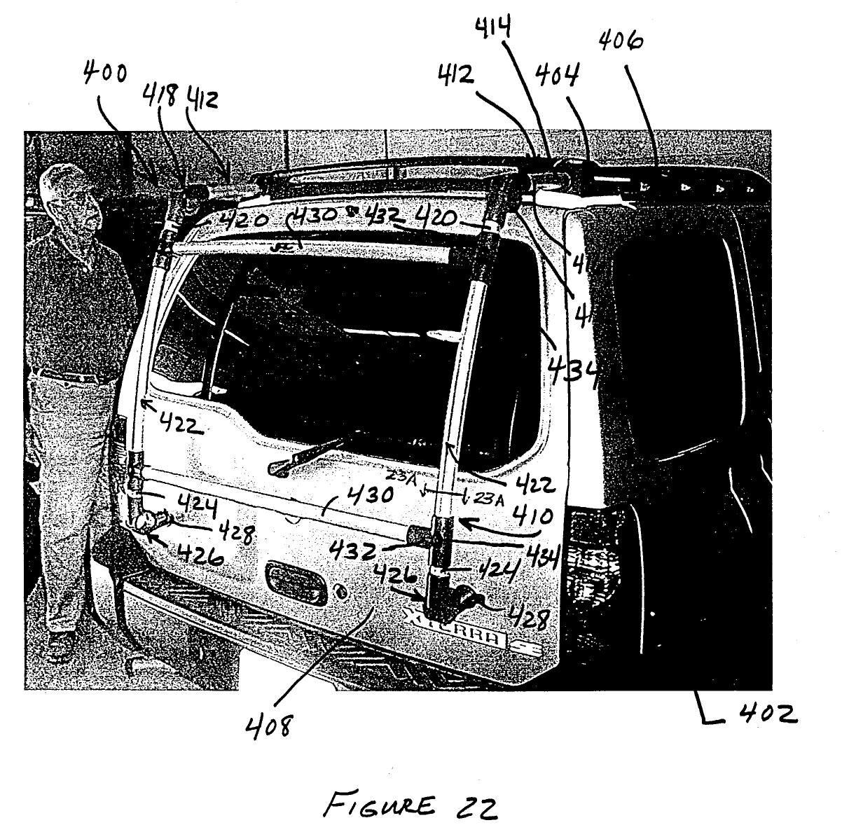

Referring to FIG. 22, an articulating vehicle article carrier 400 is shown in accordance with another alternative preferred embodiment of the present invention. The article carrier 400 differs from the previous embodiments in that it is not able to be positioned on top of the roof of vehicle 402, but is quickly and easily removable from the vehicle 402 when it is not needed. Furthermore, the construction of the article carrier 400 is such that it is able to be placed in a compact arrangement, once removed, so that it can be stored conveniently within an area such as a garage, or even within a cargo area of the vehicle itself.

With further reference to FIG. 22, a pair of supports 404 are fixedly secured to a roof 406 of a vehicle 402. A cargo supporting structure 410 having a pair of upper coupling links 412 are pivotally attached to the supports at first ends 414 thereof. Second ends 416 are attached to an upper pair of pivot assemblies 418. The pivot assemblies 418 are also attached to first ends 420 of a pair of main support members 422. These support members 422 are illustrated as tubular, slightly curving members, but it will be appreciated that they could just as easily comprise different cross-sectional shapes. The main support members 422 are preferably comprised of aluminum to provide very light weight yet structurally strong members.

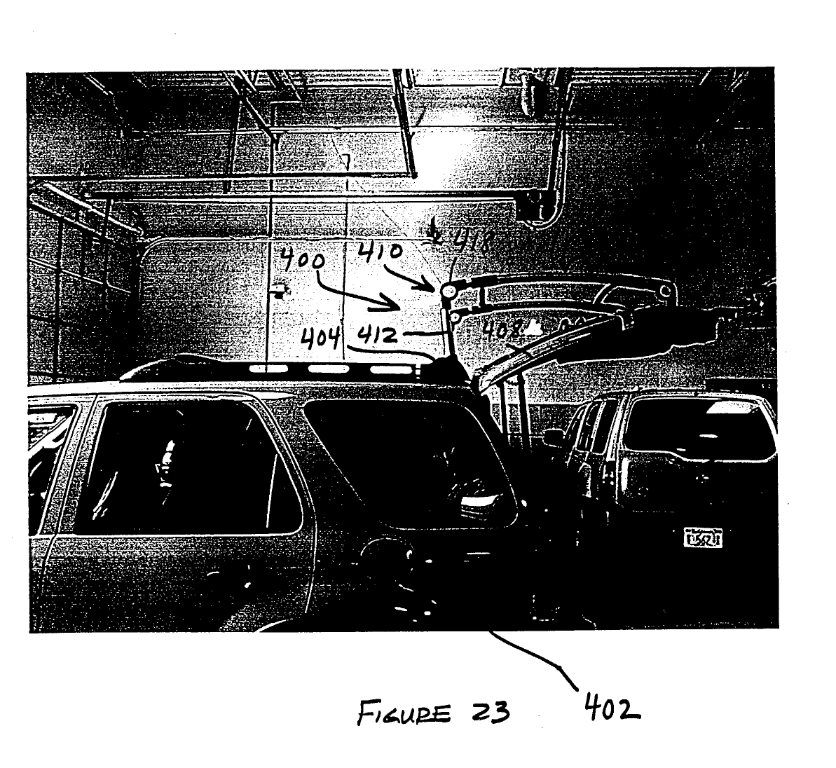

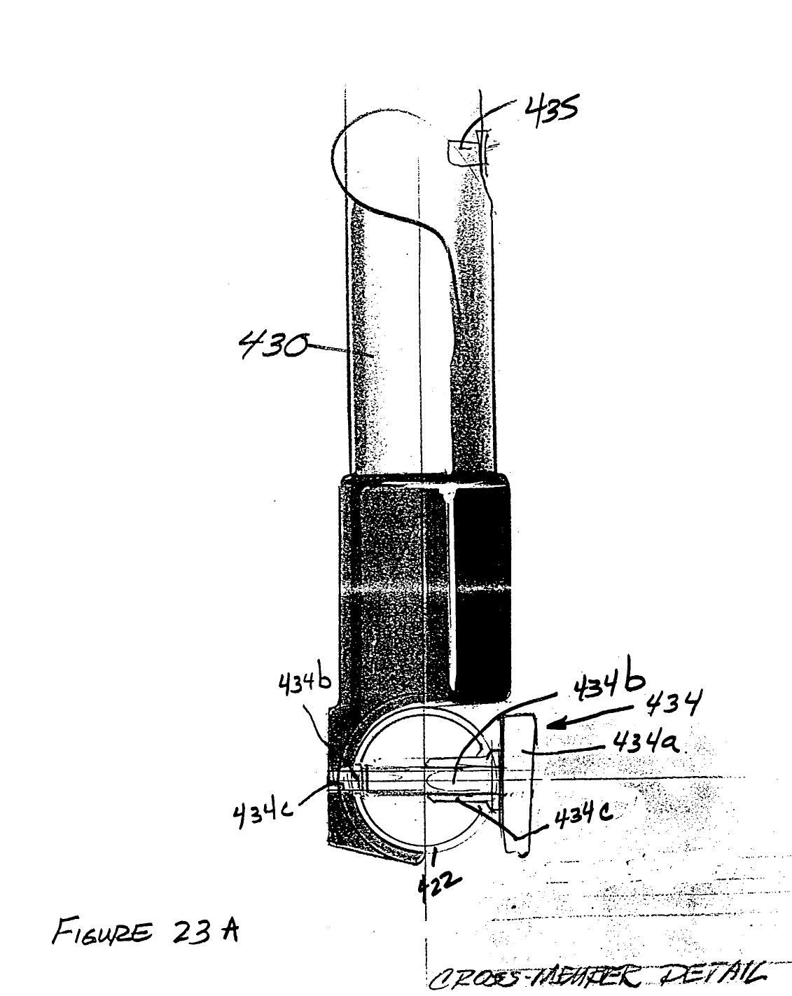

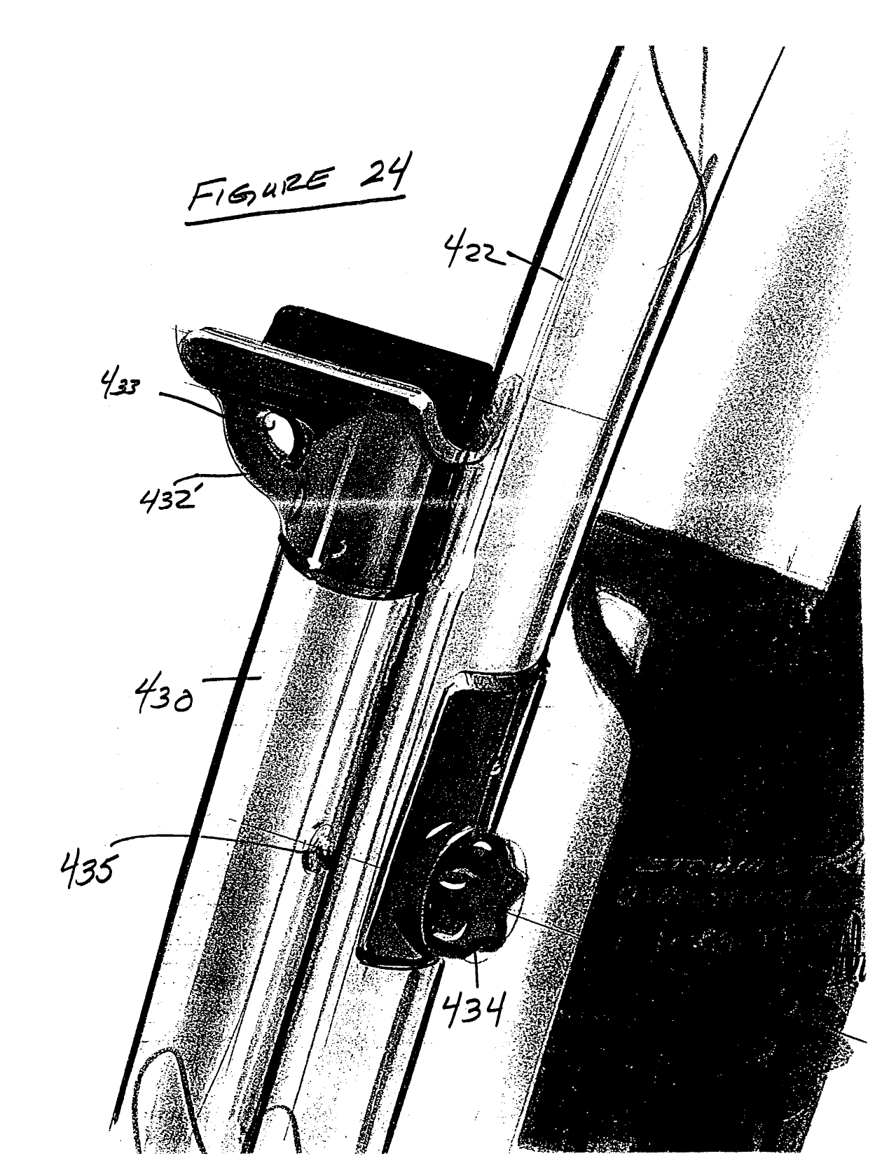

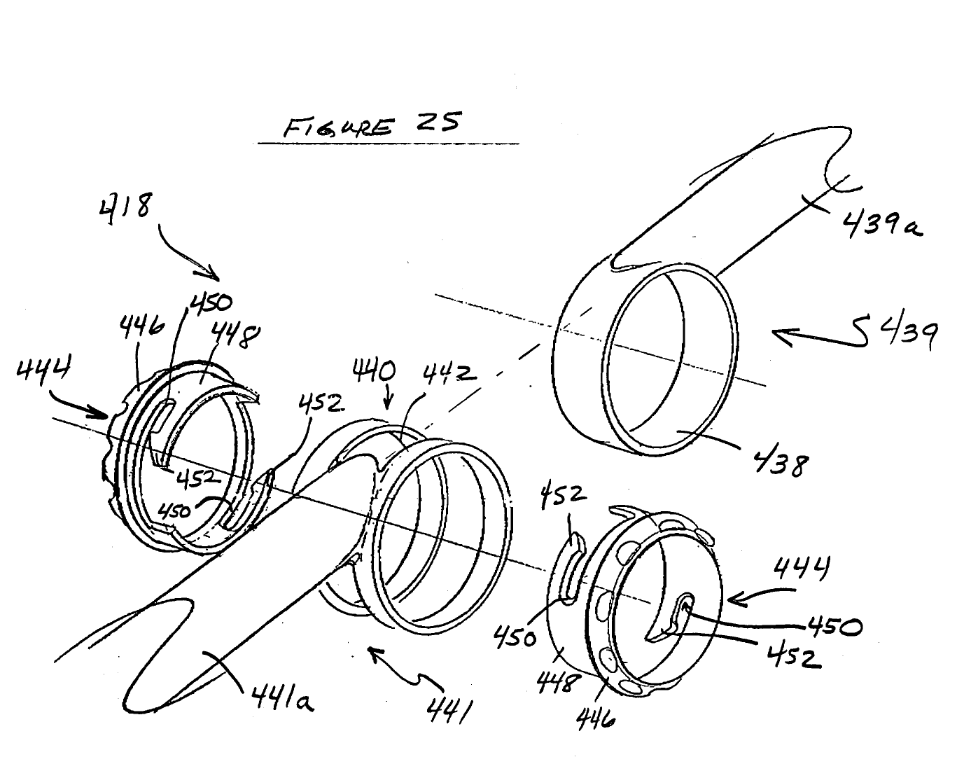

The main support members 422 are attached at second ends 424 thereof to a second pair of pivot assemblies 426. The second pair of pivot assemblies 426 are each in turn releasably engageable with a pair of anchor assemblies 428. Each of the anchor assemblies 428 are fixedly secured to a liftgate 408 of the vehicle 408. The cargo supporting structure 410 thus is positioned over the liftgate 408 when in use. Since the cargo supporting structure 410 is very lightweight, the presence of the structure 410 adds very little additional weight to the liftgate 408 when the liftgate is lifted. Thus, the effort required to lift the liftgate is almost the same whether or not the cargo supporting structure 410 is attached to the vehicle 408. FIG. 23 shows the article carrier 400 with the liftgate 408 in its raised position.

The cargo supporting structure 410 also preferably includes at least one, and more preferably a pair, of cross bars 430 supported on the main support members 422. Each of the cross bars 430 includes a mounting arm 432 at each of its opposite ends which are secured to a respective one of the main support members 422 at a predetermined position by a manually engageable fastening member 434. This coupling is shown in greater detail in FIG. 23A. The manually engageable fastening member 434 has an enlarged, manually graspable portion 434a and a partially threaded portion 434b. The partially threaded portion 434b threadably engages with a tapped hole 434c within each mounting arm 432. A rivnut 435 is also preferably included for enabling the cross bar 430 to attach parallel to the support member 422 when the article carrier 400 is detached from the vehicle 408.

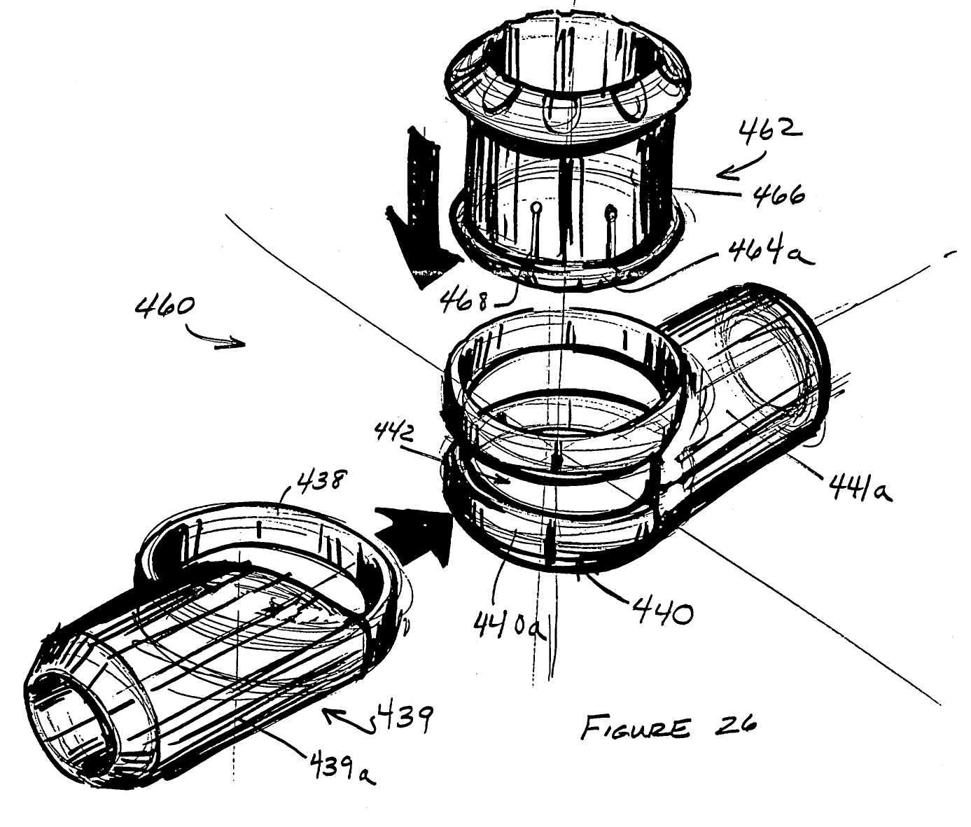

An additional feature of the cargo supporting structure 410 is that the cross bars 430 are selectively secured to the main support members 422, as illustrated in FIG. 24, when the structure 410 is removed from the vehicle 408. This is accomplished by the rivnut fastener 435 shown in FIG. 23A being included at a predetermined point along the length of each cross bar 430 to enable the separated cross bar 430 to be reattached via the fastening member 434 while positioned parallel to it. This also requires forming a hole at the proper point along the length of each support member 422 by which the fastening member 434 can be extended through. Each main support member 422 is then handled separately in a compact configuration with one of the cross bars 430 attached to it. It will be appreciated that a variety of attachment or clamping mechanisms could readily be used to releasably secure the cross bars 430 generally parallel to the main support members 422. It will also be appreciated that the mounting arm 432 could be formed with one or more loop portions to facilitate the attachment of bungee cords or other fastening straps or cords. FIG. 24 also illustrates an alternative preferred form of mounting arm 432′ having such a loop portion 433′.

Referring to FIG. 25, the construction of one of the upper pivot assemblies 418 can be seen. It will be appreciated, however, that the construction of each of the lower pivot assemblies 426 is identical to that shown in FIG. 25. A first pivot element 439 includes a tubular free flange portion 439a having an enlarged connecting ring 438. A second pivot element 441 also includes a tubular free flange portion 441a and an enlarged connecting ring 440 having a slot 442 formed therein. The free flange portion 439a is intended to be coupled to the second end 416 of the upper coupling link 412 with threaded fasteners or other conventional fastening means. The free flange portion 441a of the second pivot element 441 is intended to be secured to an end of one of the main support members 422.

The slot 442 is just slightly wider than the width of the connecting ring 438 such that it is able to receive the connecting ring 438 therein. First and second identical coupling elements 444 each include an enlarged shoulder 446 and a hub 448. The hub portion 448 has an outer diameter which permits it to snugly slide within the connecting rings 440 and 438 when the two rings 440 and 438 are coupled together. The hub portion 448 includes a pair of slots 450 each having a somewhat flexible arm 452. The slots 450 open in opposite directions.

The two coupling elements 444 are secured to each other by pressing each into the assembled connecting rings 438 and 440 from opposite sides. The coupling elements 444 are then rotated slightly such that the arms 452 of each coupling element are aligned with the slot 450 of the other coupling element. Then the coupling elements 444 are rotated in different directions, causing each arm 452 to snap into engagement with the slot 450 of the opposite coupling element 444. At this point the first and second pivot elements 439 and 441 will be securely held together while permitting pivotal movement of the upper coupling link 412 relative to its associated main support member 422. The opening formed in each pivot assembly also functions as a tie-down area where bungee cords or the like can be attached.

An alternative pivot assembly 460 is shown in FIG. 26. The pivot assembly 460 is similar to the assembly 440 with the exception of a single piece locking hub 462. The locking hub 462 includes a pair of shoulders 464 and 464a spaced apart by a central hub 466. One or more slots 468 are formed to extend into the central hub 466 from the shoulder 464a. When the locking hub 462 is inserted into the assembled combination of connecting rings 438 and 440, with the shoulder 464a being inserted first, the shoulder 464a will compress slightly as it is forced through the connecting rings 438 and 440. As it clears the second connecting ring 440a it snaps out to lock the locking hub 462 within the connecting ring 440. Each of the first pivot assemblies 418 and second pivot assemblies 426, as well as the alternative pivot assembly 460 shown in FIG. 26, are all preferably made from high strength plastic but could also be formed from other suitably strong and lightweight materials.

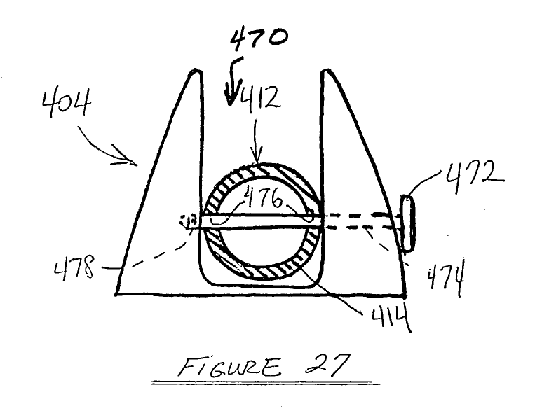

With reference to FIG. 27, one of the supports 404 includes a recess 470, in which the first end 414 of one of the upper coupling links 412 is positioned. A conventional, manually engageable locking wheel 472 having a threaded shaft 474 extends through openings 476 in the first end 414 and into a threaded recess 478. When the locking wheel 472 is completely removed from the support 404 the upper coupling link 412 can be completely removed from the support.

Referring now to FIG. 28, one of the anchor assemblies 428 is shown. The anchor assembly 428 includes a flange 480 having a pair of openings 482. The openings 482 accommodate conventional fastening elements 483 that are used to secure the flange 480 to a suitable reinforcing member 484 within the liftgate 408. The anchor assembly 428 also includes a tubular neck 486 integrally formed with or otherwise secured to the flange 480, and having a tapering end 486a. The neck 486 has an opening 488 for receiving a locking element 490 therethrough. The locking element 490 is inserted from the rear (i.e., initially through the flange portion 480) into the interior area of the tubular neck 486. The locking element 490 includes a biasing element 492 which is a Z-shaped piece of spring steel having a head 494 sized to protrude through the opening 488. The head 494 preferably has a beveled edge.

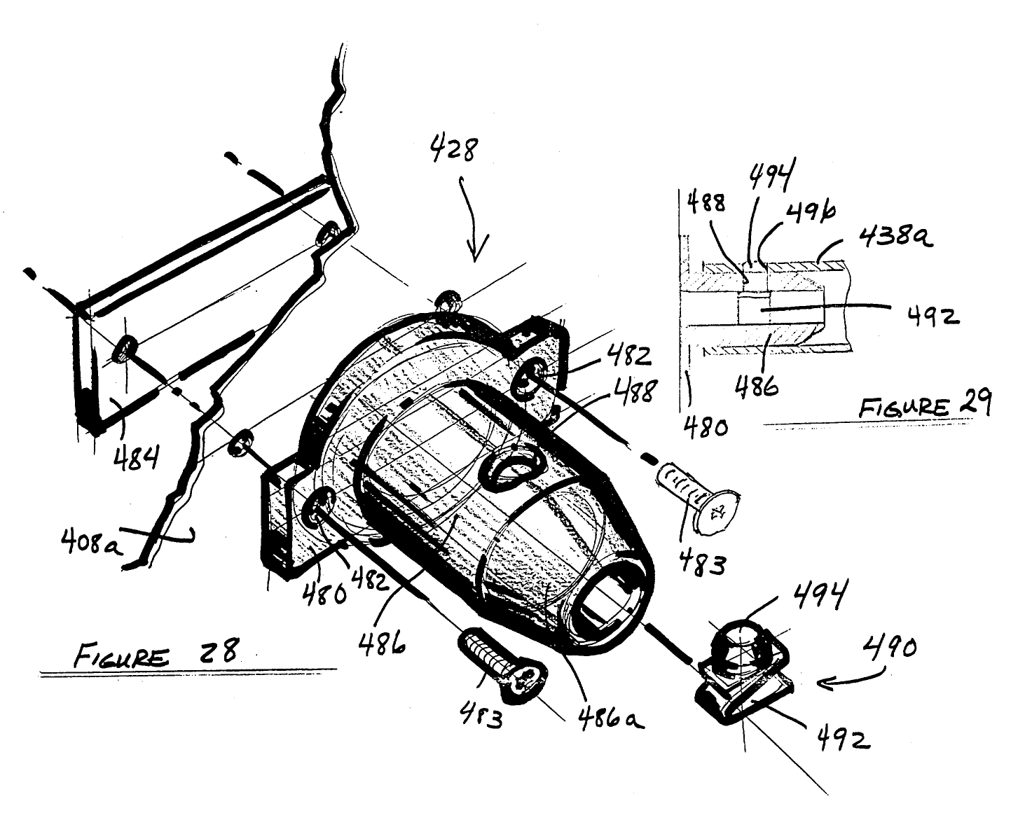

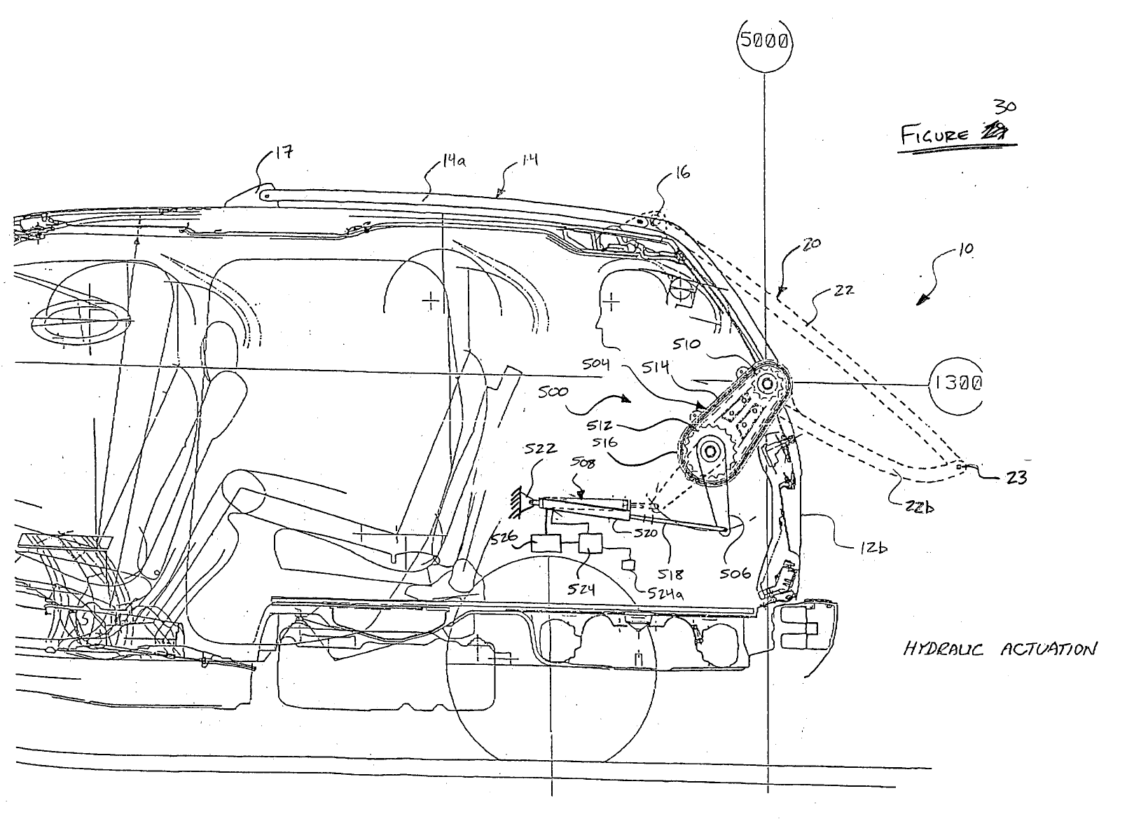

With reference to FIG. 29, to connect the lower pivot assembly 426 to the associated anchor assembly 428 the free flange 438a is pushed over the tubular neck 486. The free flange 438a includes an opening 496 aligned with the opening 488 in the neck 486 when the free flange 438a is urged over the neck 486. When this occurs, the head 494 of the locking element 490 is momentarily depressed as the free flange 438a initially slides over the neck 486. As soon as the opening 496 reaches the opening 488, the head 494 snaps into the opening 488. To release the free flange 438a, the head portion 494 is pushed down, and the free flange 438a is pulled away from the neck 486. The beveled edge of the head 494 assists in retracting the head 494.

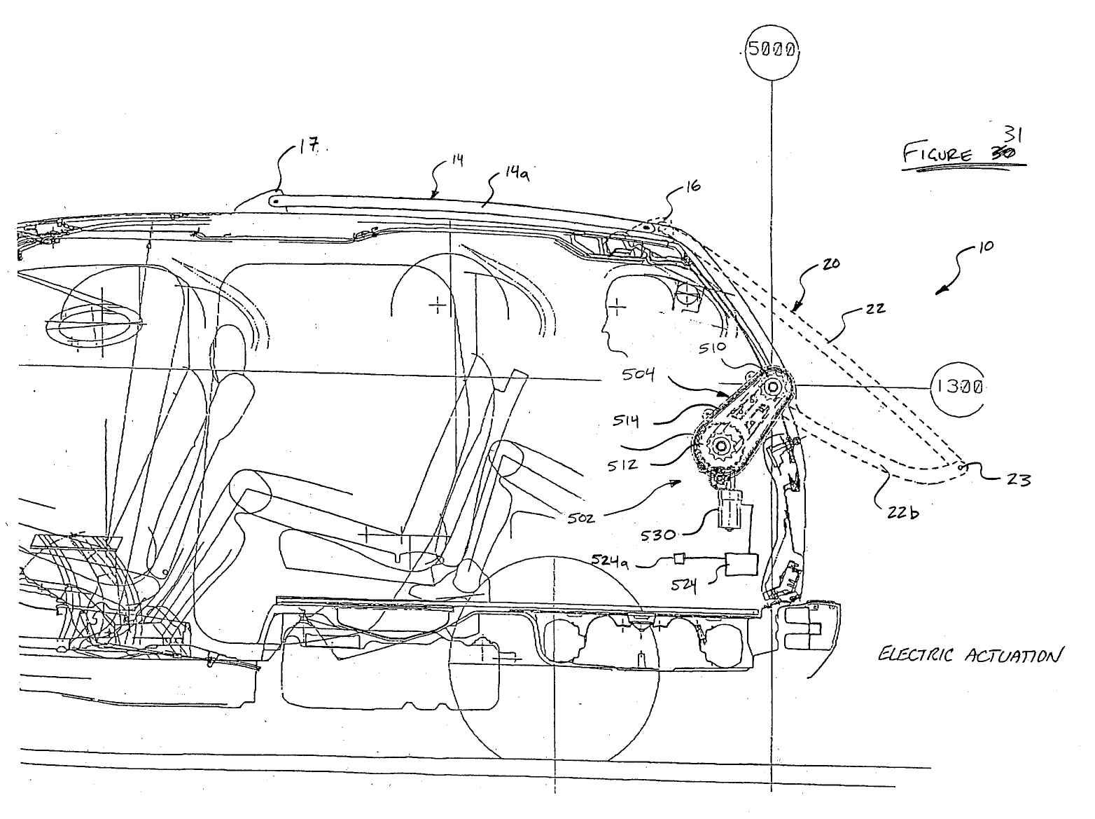

As described in detail above, the apparatus 10 is manually operable to move the cargo supporting structure 20 between the lowered position and the stowed position. Referencing FIGS. 30 and 31, alternative preferred embodiments of the present invention are shown that provide power assisted lifting of the cargo supporting structure 20. These embodiments include hydraulic and electrical actuators 500, 600, respectively, to mechanically operate the apparatus 10. With particular reference to FIG. 30, the cargo supporting structure 20 includes lower side members 22b that are interconnected with ends of the side members 22 by a hinge 23. As a result of the hinged interconnection, the latching assemblies 32, are not required. An end of each of the lower side members 22b is pivotally interconnected to and supported by the hydraulic actuator 500.

The hydraulic actuator 500 includes a gearbox 504, an actuation arm 506, and a hydraulic piston 508. The gearbox 504 includes upper and lower sprocket gears 510, 512, respectively, interconnected by a chain, or belt 514. The components of the gearbox 504 are enclosed in a housing 516. The lower sprocket 512 is preferably of a larger diameter than the upper sprocket 510. In this manner, as the lower sprocket 512 is induced to rotate, the upper sprocket 510 rotates at a greater rate, as described in further detail below. The actuation arm 506 is fixed for rotation with and extends from the lower sprocket 512. An end of the actuation arm 506 is pivotally connected to a piston rod 518 of the hydraulic piston 508. A piston housing 520 of the hydraulic piston 508 is anchored to a frame or frame-like structure 522 of the vehicle. A controller 524 communicates with the hydraulic piston 508 to selectively enable a flow of pressurized fluid thereto from a pressurized fluid source 526. It is anticipated that the hydraulic piston 508 may be either hydraulic or pneumatic.

In operation, an operator signals the controller 524 via a suitable switch 524a to raise the apparatus 10. In response, the controller 524 signals a flow of pressurized fluid to the hydraulic piston 508, thereby actuating the hydraulic piston 508. Actuation of the hydraulic piston 508 induces the actuation arm 506 to pivot, thereby rotating the lower sprocket 512. Rotation of the lower sprocket 512 induces rotation of the upper sprocket 510 through the chain 514. More particularly, the upper sprocket 510 rotates at a greater rotational speed than the lower sprocket 512 as a result of being smaller in diameter than the lower sprocket 512. The lower side members 22b are induced by the rotation of the upper sprocket 510 to pivot upwards. The angular speed of the pivoting lower side members 22b is greater than that of the actuation arm 506 as a result of the gearbox 504 configuration. Upwards pivoting of the lower side members 22b induces upwards pivoting of the side members 22 about the rear support 16, as discussed in detail hereinabove, to ultimately position the cargo supporting structure 20 in the stowed position.

With particular reference to FIG. 31, an alternative preferred form 600 of the system 500 is shown that includes an electrical motor in lieu of a hydraulic or pneumatic lifting system. Components corresponding to those of system 500 are designated by reference numerals increased by 100 over those used in connection with FIG. 30. With this embodiment the electrical actuator system 600 includes an electrical actuator 602. Similar to the hydraulic actuator 500, the electrical actuator 602 includes a gearbox 604 having upper and lower sprocket gears 610, 612 interconnected by a chain, or belt 614. The electrical actuator 602 further includes an electric motor 630 for driving the lower sprocket 612. A controller 624 communicates with the electric motor 630 to selectively drive the lower sprocket 612 in either a clock-wise (CW), or counterclockwise (CCW) direction. Actuation of the electric motor 630 induces rotation of the lower sprocket 612, which in turn induces rotation of the upper sprocket 610 through the chain 614. More particularly, the upper sprocket 610 rotates at a greater rotational speed than the lower sprocket 612 as a result of being smaller in diameter than the lower sprocket 612. The lower side members 22b are induced to pivot upwards by the rotation of the upper sprocket 610. Upwards pivoting of the lower side members 22b induces upwards pivoting of the side members 22 about the rear support 16, as discussed in detail hereinabove, to ultimately position the cargo supporting structure 20 in the stowed position.

The preferred embodiments 500 and 600 thus provide for power assisted lifting and lowering of the cargo supporting structure 20. This function enhances the utility of the article carrier of the present invention by alleviating the need for the user to manually lift one end of the cargo supporting structure 20. This feature is anticipated to be particularly helpful for shorter individuals who might otherwise have difficulty manipulating the cargo supporting structure 20 onto or from the roof of the vehicle.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle article carrier for carrying articles adjacent a liftgate of a motor vehicle, the motor vehicle having a roof support structure and a bumper, the vehicle article carrier comprising:
a first pair of links pivotally connectable at a first end with the roof support structure of the motor vehicle;
a second pair of links pivotally connectable at a first end in a first position to the liftgate of the motor vehicle and in a second position to the bumper of the motor vehicle, said second pair of links each having a second end pivotally coupled to a second end of said first pair of links; and
a cross link releasably coupling said second pair of links to provide an article support structure,
wherein said first pair of links, said second pair of links, and said cross link are readily removable from said support structures by a user.

2. The vehicle article carrier according to claim 1, further comprising:
a pair of lower locking assemblies separately coupled to said second pair of links, said pair of lower locking assemblies being capable of releasably securing said second pair of links to the motor vehicle in said first position and said second position, each of said pair of lower locking assemblies having a main member, a pivoting member pivotally coupled to said main member, and a spring member biasing said pivoting member into a closed position.

3. The vehicle article carrier according to claim 1, further comprising:
a pair of upper locking assemblies separately coupled to said first pair of links, said pair of upper locking assemblies being capable of releasably securing said first pair of links to the roof structure of the motor vehicle, each of said pair of upper locking assemblies having a main member, a pivoting member pivotally coupled to said main member, and a spring member biasing said pivoting member into a closed position.

4. The vehicle article carrier according to claim 1, further comprising:
a pair of fastening members releasably coupling said cross link to said second pair of links, each of said pair of fastening members having a mounting member slidably received within a track formed in each of said second pair of links, a manually adjustable member threadedly engaging said mounting member to urge said mounting member against said track to retain said cross link in a predetermined position.

5. The vehicle article carrier according to claim 1, wherein said first pair of links, said second pair of links, the liftgate of the motor vehicle, and the roof support structure of the motor vehicle together are capable of defining a four-bar linkage.

6. A vehicle article carrier for carrying articles adjacent a liftgate of a motor vehicle, the motor vehicle having a roof support structure and a bumper, the vehicle article carrier comprising:
a first pair of links pivotally connectable at a first end with the roof support structure of the motor vehicle;
a second pair of links pivotally connectable at a first end in a first position to the liftgate of the motor vehicle and in a second position to the bumper of the motor vehicle, said second pair of links each having a second end pivotally coupled to a second end of said first pair of links, each of said second pair of links having a track portion formed longitudinally along at least a portion thereof;
a cross link releasably coupling said second pair of links to provide an article support structure; and
a pair of fastening members releasably coupling said cross link to said second pair of links, each of said pair of fastening members having a mounting member slidably received within said track formed in each of said second pair of links, a manually adjustable member threadedly engaging said mounting member to urge said mounting member against said track to retain said cross link in a predetermined position,
wherein said first pair of links, said second pair of links, and said cross link are readily removable from said support structures by a user.

7. The vehicle article carrier according to claim 6, further comprising:
a pair of lower locking assemblies separately coupled to said second pair of links, said pair of lower locking assemblies being capable of releasably securing said second pair of links to the motor vehicle in said first position and said second position, each of said pair of lower locking assemblies having a main member, a pivoting member pivotally coupled to said main member, and a spring member biasing said pivoting member into a closed position.

8. The vehicle article carrier according to claim 6, further comprising:
a pair of upper locking assemblies separately coupled to said first pair of links, said pair of upper locking assemblies being capable of releasably securing said first pair of links to the roof structure of the motor vehicle, each of said pair of upper locking assemblies having a main member, a pivoting member pivotally coupled to said main member, and a spring member biasing said pivoting member into a closed position.

9. The vehicle article carrier according to claim 6, wherein said first pair of links, said second pair of links, the liftgate of the motor vehicle, and the roof support structure of the motor vehicle together are capable of defining a four bar linkage.

10. A vehicle article carrier for carrying articles adjacent a liftgate of a motor vehicle, the motor vehicle having a roof support structure and a bumper, the vehicle article carrier comprising:
a first pair of links pivotally connectable at a first end with the roof support structure of the motor vehicle;
a second pair of links pivotally connectable at a first end in a first position to the liftgate of the motor vehicle and in a second position to the bumper of the motor vehicle, said second pair of links each having a second end pivotally coupled to a second end of said first pair of links, each of said second pair of links having a track portion formed longitudinally along at least a portion thereof;
a cross link releasably coupling said second pair of links to provide an article support structure; and
a pair of fastening members releasably coupling said cross link to said second pair of links, each of said pair of fastening members having a mounting member slidably received within said track formed in each of said second pair of links, a manually adjustable member threadedly engaging said mounting member to urge said mounting member against said track to retain said cross link in a predetermined position;
a pair of lower locking assemblies separately coupled to said second pair of links, said pair of lower locking assemblies being capable of releasably securing said second pair of links to the motor vehicle in said first position and said second position, each of said pair of lower locking assemblies having a main member, a pivoting member pivotally coupled to said main member, and a spring member biasing said pivoting member into a closed position; and
a pair of upper locking assemblies separately coupled to said first pair of links, said pair of upper locking assemblies being capable of releasably securing said first pair of links to the roof structure of the motor vehicle, each of said pair of upper locking assemblies having a main member, a pivoting member pivotally coupled to said main member, and a spring member biasing said pivoting member into a closed position,
wherein said first pair of links, said second pair of links, and said cross link are readily removable from said support structures by a user.

11. The vehicle article carrier according to claim 10, wherein said first pair of links, said second pair of links, the liftgate of the motor vehicle, and the roof support structure of the motor vehicle together are capable of defining a four bar linkage.
